(19) United States
(12) Patent Application Publication
(10) Pub. No.: US 2022/0378273 A1
(43) Pub. Date: Dec. 1, 2022

(54) SEGMENT-CONNECTED STRUCTURE FOR HANDLE

(71) Applicant: JIAXING JACKSON TRAVEL PRODUCTS CO., LTD., Jiaxing (CN)

(72) Inventors: Xuelin ZHU, Jiaxing (CN); Danjun CHI, Jiaxing (CN)

(73) Assignee: JIAXING JACKSON TRAVEL PRODUCTS CO., LTD., Jiaxing (CN)

(21) Appl. No.: 17/774,871

(22) PCT Filed: Nov. 2, 2020
(86) PCT No.: PCT/CN2020/125760

§ 371 Date: May 6, 2022

(30) Foreign Application Priority Data
Nov. 6, 2019 (CN) 201921905774.3

(51) Int. Cl. A47L 13/42; B25G 1/04

(52) U.S. Cl. CPC A47L 13/42; B25G 1/04

(57) ABSTRACT

A segment-connected structure for a handle, relating to the field of household cleaning appliance accessories, includes a first tube and a second tube which are coaxial, and further includes a connecting member. The connecting member includes a first end portion and a second end portion. The first end portion and the second end portion are connected through a flexible connecting structure, and are respectively connected to the first tube and the second tube. The first tube and the second tube are detachably connected. The segment-connected structure has a simple structure, can change the length of a handle conveniently, can avoid the loss of parts when the length of the handle is changed, and is suitable for the application to a handle of a household cleaning appliance.

### CROSS REFERENCE TO THE RELATED APPLICATIONS

This application is the national phase entry of International Application No. PCT/CN2020/125760, filed on Nov. 2, 2020, which is based upon and claims priority to Chinese Patent Application No. 201921905774.3, filed on Nov. 6, 2019, the entire contents of which are incorporated herein by reference.

### TECHNICAL FIELD

The invention relates to the field of household cleaning appliance accessories, in particular to a segment-connected structure for a handle.

### BACKGROUND

The handle of some common household cleaning appliances such as mops, brooms, floor mopping machines and cleaning brushes generally has a fixed length and occupies too much space, thus inconvenient to package, high in transport cost, and large in storage space. If the handle is disassembled to save space when packaged, transported or stored, disassembled parts may be lost or need to be assembled again, thus causing inconvenience to users.

### SUMMARY

The objective of the invention is to overcome the defects of the prior art by providing a segment-connected structure for a handle, which can be folded to change the length of a handle and will not generate separate parts when folded.

The technical solution adopted by the invention to solve the above-mentioned problems is to provide a segment-connected structure for a handle, which comprises a first tube and a second tube which are coaxial, and further comprises a connecting member, wherein the connecting member comprises a first end portion and a second end portion, the first end portion and the second end portion are connected through a flexible connecting structure and are respectively connected to the first tube and the second tube, and the first tube and the second tube are detachably connected.

Further, the first tube and the second tube are connected in a threaded manner, and the second end portion is circumferentially rotatably connected to the second tube, or the first end portion is circumferentially rotatably connected to the first tube.

Further, the second tube is fixedly sleeved with a lock sleeve, the lock sleeve is provided with an internal threaded segment towards the first tube, the internal threaded segment extends out of the second tube, and the first tube is provided with an external threaded segment matched with the internal threaded segment.

Further, the second tube sleeves the first tube when the lock sleeve is rotatably connected and fixed to the first tube.

Further, the connecting member further comprises an intermediate segment connected between the first end portion and the second end portion, the first end portion is connected to the intermediate segment through the flexible connecting structure, and the second end portion is connected to the intermediate segment through the flexible connecting structure.

Further, the second end portion is provided with a projection, and a convex surface that abuts against the projection to prevent the connecting member from moving away from the second tube is formed in the second tube.

Further, the first end portion is inserted into the first tube.

Further, the first tube is formed with a locating groove towards the first end portion, and a locating protrusion matched with and embedded in the locating groove is formed on the first end portion.

Further, the connecting member is of an integrated structure.

Further, the flexible connecting structure realizes a connection through rubber, a corrugated tube, or a rope.

Further, the first tube and the second tube are connected in a threaded manner, and the flexible connecting structure realizes a connection through a rope.

The segment-connected structure for a handle has a simple structure, can change the length of a handle conveniently, can avoid the loss of parts when the length of the handle is changed, and is suitable for the application to a handle of a household cleaning appliance.

### BRIEF DESCRIPTION OF THE DRAWINGS

The specific implementation of the invention will be described in further detail below in conjunction with the accompanying drawings.

FIG. 1 is an exploded view of a segment-connected structure for a handle according to one embodiment;

FIG. 2 is a schematic diagram of the segment-connected structure for a handle in an unfolded state according to one embodiment;

FIG. 3 is a schematic diagram of the segment-connected structure for a handle in a folded state according to one embodiment;

### REFERENCE SIGNS

1, first tube; 11, locating groove; 12, external threaded segment;
2, second tube; 21, convex surface;
3, connecting member; 31, first end portion; 31a, positioning protrusion; 32, second end portion; 32a, projection; 33, intermediate segment;
4, lock sleeve; 41, internal threaded segment.

### DETAILED DESCRIPTION OF THE EMBODIMENTS

To gain a better understanding of the objectives, technical solutions and advantages of the invention, the invention will be described in further detail below in conjunction with the accompanying drawings and embodiments. It should be understood that the specific embodiments described below are merely used to explain the invention, and are not used to limit the invention.

### Embodiment 1

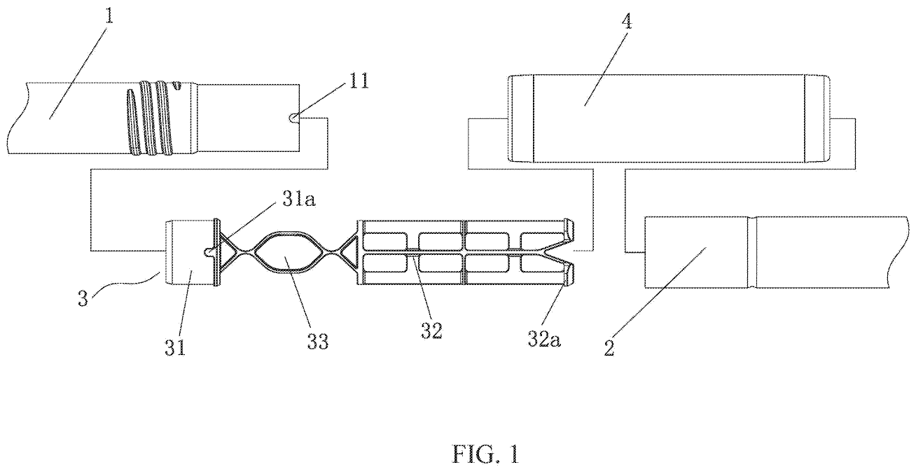

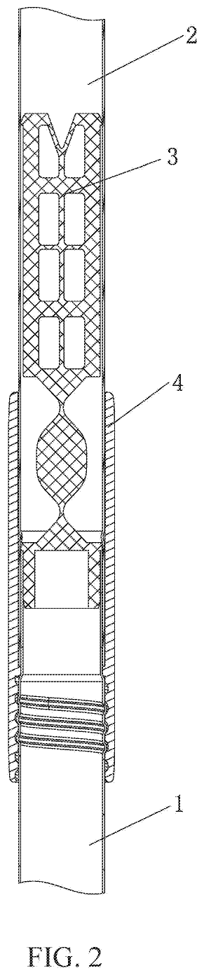

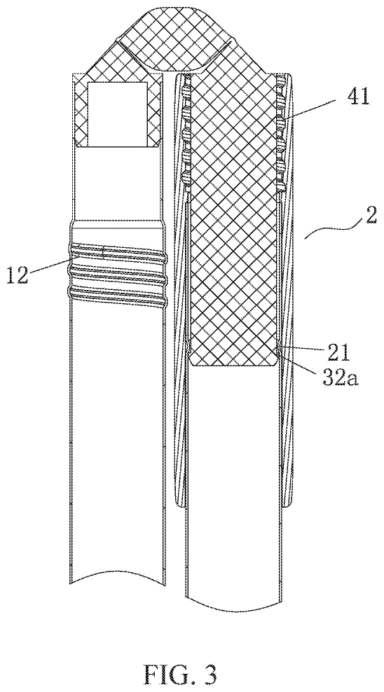

As shown in FIG. 1-FIG. 3, a segment-connected structure for a handle comprises a first tube 1, a second tube 2 and a connecting member 3. The first tube 1 and the second tube 2 are coaxial. The connecting member 3 comprises a first end portion 31 and a second end portion 32. The first end portion 31 and the second end portion 32 are connected through a flexible connecting structure. The first end portion 31 and the second end portion 32 are respectively connected to the first tube 1 and the second tube 2. The first tube 1 and the second tube 2 are detachably connected. Flexible connection, also referred to as bendable connection, is a connection manner allowing connected portions to telescope or rotate in an axial direction and to move in the axial direction.

In this embodiment, the first tube 1 and the second tube 2 are fixed in an unfolded state, so that the first tube 1 and the second tube 2 are stably connected. When to be folded, the first tube 1 and the second tube 2 are separated; and the first end portion 31 and the second end portion 32 are folded through the flexible connecting structure, and the first tube 1 and the second tube 2 are folded accordingly.

The segment-connected structure for a handle is particularly suitable for common household cleaning appliances such as mops, brooms, floor mopping machines, and cleaning brushes. When the segment-connected structure for a handle is in the unfolded state, mops using the segment-connected structure may be used for cleaning. When the segment-connected structure for a handle is in the folded state, mops using the segment-connected structure may be packaged, transported or stored.

The first tube 1 and the second tube 2 are detachably connected such as through a buckle or by insertion. In this embodiment, the first tube 1 and the second tube 2 are connected in a threaded manner, and the second end portion 32 is circumferentially rotatably connected to the second tube 2, or the first end portion 31 is circumferentially rotatably connected to the first tube 1, so that the rotation of the first tube 1 and the second tube 2 will not be affected. When detachably connected in the threaded manner, the first tube 1 and the second tube 2 are convenient to assemble and disassemble and capable of being used by users repeatedly.

In this embodiment, the second tube 2 is fixedly sleeved with a lock sleeve 4. The lock sleeve 4 is provided with an internal threaded segment 41 towards the first tube 1, the inner threaded segment 41 extends out of the second tube 2, and the first tube 1 is provided with an external threaded segment 12 matched with the internal threaded segment 41. Wherein, when the lock sleeve 4 is rotatably connected and fixed to the first tube 1, the second tube 2 sleeves the first tube 1. The first tube 1 is sleeved with the second tube 2, so that the first tube 1 and the second tube 2 are firmly connected in the unfolded state and are more stable in use.

Users may hold the lock sleeve 4 to exert force to assemble and disassemble the first tube 1 and the second tube 2, so that the segment-connected structure for a handle can be actually used more easily, and the fabrication requirement of a joint of the first tube 1 and the second tube 2 is lowered.

In this embodiment, the connecting member 3 further comprises an intermediate segment 33. The intermediate segment 33 is connected between the first end portion 31 and the second end portion 32. The first end portion 31 and the intermediate segment 33 are connected through the flexible connecting structure, and the second end portion 32 and the intermediate segment 33 are connected through the flexible connecting structure. Through the intermediate segment 33, the rotation angle of the first end portion 31 and the second end portion 32 may be reduced, and excessive rotation is avoided, which may otherwise cause deformation or shorten the service life. The first end portion 31, the intermediate segment 33 and the second end portion 32 may be integrally molded by casting, so that the structure is simple.

The first end portion 31 and the second end portion 32 are connected to the first tube 1 and the second tube 2, that is, two ends of the connecting member 3 are connected to the first tube 1 and the second tube 2, in the following manner: one end of the connecting member 3 is fixedly connected to the first tube 1 and the other end of the connecting member 3 is axially telescopically connected to the second tube 2; or, the two ends of the connecting member 3 are axially telescopically connected to the first tube 1 and the second tube 2 respectively. No matter whether the connecting member 3 is fixedly connected to the first tube or the second tube or axially telescopically connected to the first tube 1 or the second tube 2, the objective of the invention will not be affected. All these transformations should fall within the protection scope of this embodiment.

In this embodiment, the second end portion 31 and the second tube 2 are connected in the following manner: the second end portion 32 is provided with a projection 32a, and a convex surface 21 that abuts against the projection 32a to prevent the connecting member 2 from moving away from the second tube 2 is formed in the second tube 2, so that the connecting member 3 is prevented from being separated from the second tube 2. In this way, the second end portion 31 and the second tube 2 are flexible or rotatable in the axial direction.

In this embodiment, the first end portion 31 is fixedly connected to the first tube 1. Specifically, the first end portion 31 is inserted into the first tube 1.

Further, the first tube 1 is formed with a locating groove 11 towards the first end portion 31, and a locating protrusion 31a matched with and embedded into the locating groove 11 is formed on the first end portion 31. The assembly efficiency is improved through the cooperation of the locating groove 11 and the locating protrusion 31a.

In this embodiment, the connecting member 3 is of an integrated structure. The connecting member 3 may be molded from plastic by casting. The integrated structure of the connecting member 3 is simple, and particularly, no other parts need to be additionally disposed on the flexible connecting structure.

The flexible connecting structure in the invention may realize a flexible connection through plastic, rubber, a corrugated tube, or a rope.

### Embodiment 2

The first tube and the second tube are connected in a threaded manner, and the flexible connecting structure realizes connection through a rope.

The embodiments described above in the specification are merely illustrative examples of the invention. Various amendments or supplements or similar substitutions made to the above specific embodiments by those skilled in the art without departing from the contents in the specification of the invention or exceeding the scope defined by the claims of the invention should also fall within the protection scope of the invention.

What is claimed is:

1. A segment-connected structure for a handle, comprising a first tube, a second tube and a connecting member, wherein the first tube and the second tube are coaxial, the connecting member comprises a first end portion and a second end portion, the first end portion and the second end portion are connected through a flexible connecting structure and are respectively connected to the first tube and the second tube, and the first tube and the second tube are detachably connected.

2. The segment-connected structure for the handle according to claim 1, wherein the first tube and the second tube are connected in a threaded manner, and the second end portion is circumferentially rotatably connected to the second tube, or the first end portion is circumferentially rotatably connected to the first tube.

3. The segment-connected structure for the handle according to claim 1, wherein the second tube is fixedly sleeved with a lock sleeve, the lock sleeve is provided with an internal threaded segment towards the first tube, the internal threaded segment extends out of the second tube, and the first tube is provided with an external threaded segment matched with the internal threaded segment.

4. The segment-connected structure for the handle according to claim 3, wherein the second tube sleeves the first tube when the lock sleeve is rotatably connected and fixed to the first tube.

5. The segment-connected structure for the handle according to claim 2, wherein the connecting member further comprises an intermediate segment connected between the first end portion and the second end portion, the first end portion is connected to the intermediate segment through the flexible connecting structure, and the second end portion is connected to the intermediate segment through the flexible connecting structure.

6. The segment-connected structure for the handle according to claim 1, wherein the second end portion is provided with a projection, and a convex surface is formed in the second tube, wherein the convex surface abuts against the projection to prevent the connecting member from moving away from the second tube.

7. The segment-connected structure for the handle according to claim 1, wherein the first end portion is inserted into the first tube.

8. The segment-connected structure for the handle according to claim 7, wherein the first tube is formed with a locating groove towards the first end portion, and a locating protrusion matched with and embedded in the locating groove is formed on the first end portion.

9. The segment-connected structure for the handle according to claim 1, wherein the connecting member is of an integrated structure.

10. The segment-connected structure for the handle according to claim 1, wherein the flexible connecting structure realizes a connection through rubber, a corrugated tube, or a rope.

11. The segment-connected structure for the handle according to claim 1, wherein the first tube and the second tube are connected in a threaded manner, and the flexible connecting structure realizes a connection through a rope.

12. The segment-connected structure for the handle according to claim 2, wherein the second tube is fixedly sleeved with a lock sleeve, the lock sleeve is provided with an internal threaded segment towards the first tube, the internal threaded segment extends out of the second tube, and the first tube is provided with an external threaded segment matched with the internal threaded segment.

13. The segment-connected structure for the handle according to claim 2, wherein the second end portion is provided with a projection, and a convex surface is formed in the second tube, wherein the convex surface abuts against the projection to prevent the connecting member from moving away from the second tube.

14. The segment-connected structure for the handle according to claim 2, wherein the first end portion is inserted into the first tube.

15. The segment-connected structure for the handle according to claim 2, wherein the connecting member is of an integrated structure.

16. The segment-connected structure for the handle according to claim 2, wherein the flexible connecting structure realizes a connection through rubber, a corrugated tube, or a rope.
